(19) United States
(12) Patent Application Publication
(10) Pub. No.: US 2015/0009563 A1
(43) Pub. Date: Jan. 8, 2015

(54) LIGHT CONTROL FILM AND P-POLARIZATION MULTI-LAYER FILM OPTICAL FILM STACK

(71) Applicant: 3M INNOVATIVE PROPERTIES COMPANY, St. Paul, MN (US)

(72) Inventors: Michael E. Lauters, Hudson, WI (US); Yufeng Liu, Woodbury, MN (US); Stephen A. Johnson, Woodbury, MN (US); Michael F. Weber, Shoreview, MN (US); Huiwen Tai, Lake Elmo, MN (US)

(21) Appl. No.: 14/354,340

(22) PCT Filed: Mar. 11, 2013
(86) PCT No.: PCT/US13/30097

§ 371 Date: Apr. 25, 2014

Related U.S. Application Data
(60) Provisional application No. 61/615,378, filed on Mar. 26, 2012.

(51) Int. Cl. G02B 5/30

(52) U.S. Cl. CPC G02B 5/3083
USPC 359/485.03

(57) ABSTRACT

The present invention generally relates to a film stack having a light-control film, such as a privacy filter, and a p-polarization color shifting film. The present invention also relates to articles, such as displays, incorporating the same.

### FIELD OF THE INVENTION

The present invention generally relates to a film stack having a light-control film, such as a privacy filter, and a color shifting film. The present invention also relates to displays incorporating the same.

### BACKGROUND

A light-control film is an optical film that is configured to regulate the directionality of transmitted light. One type of light-control film comprises a light transmissive film having a plurality of parallel grooves wherein the grooves are formed of a light absorbing material. Such films have also been described as light-collimating films. Depending on the orientation of the grooves, the pitch, and the geometry of the grooves (e.g., the side-wall angle), the privacy filter may provide for maximum transmission at a predetermined angle of incidence with respect to the image plane and provide for image cut-off or black-out along a given polar coordinate (e.g., horizontally in the case of so-called privacy filters, or vertically when such light-control films are integrated into instrument panel displays for automobiles).

LCFs may be placed proximate a display surface, image surface, or other surface to be viewed. Typically, LCFs are designed such that at normal incidence, (i.e., 0 degree viewing angle, when a viewer is looking at an image through the LCF in a direction that is perpendicular to the film surface and image plane), the image is viewable. As the viewing angle increases, the amount of light transmitted through the LCF decreases until a viewing cutoff angle is reached where substantially all the light is blocked by the light-absorbing material and the image is no longer viewable. When used as a so-called privacy filter (for instance, for liquid crystal displays in computer monitors or laptop displays), this characteristic of LCFs can provide privacy to a viewer by blocking observation by others that are outside a typical range of viewing angles.

LCFs can be prepared, for instance, by molding and ultraviolet curing a polymerizable resin on a polycarbonate substrate. Such LCFs are commercially available from 3M Company, St. Paul, Minn., under the trade designation “3M™ Filters for Notebook Computers and LCD Monitors”.

Conventional privacy filter have been described as turning from clear to black outside the field of view.

WO2010/090924 describes a film stack (i.e. a hybrid privacy filter) comprising a light control (e.g. privacy) film and a color shifting film.

### SUMMARY

Although film stacks (i.e. a hybrid privacy filter) comprising a light control (e.g. privacy) film and a color shifting film have been described, industry would find advantage in stacks comprising certain color shifting film that can provided specific (e.g. coloration) properties without sacrificing on-axis brightness (i.e. transmission).

In one embodiment an optical film stack is described comprising: a light control film; and a p-polarization color shifting film. The p-polarization color shifting film comprises alternating layers of at least a first and second material, the alternating layers defining a coordinate system with mutually orthogonal x- and y-axes extending parallel to the layers and with a z-axis orthogonal to the x- and y-axes, the alternating layers having a refractive index difference along the x- and y-axes of no more than 0.015, the alternating layers also having a refractive index difference along the z-axis of at least 0.1.

In some embodiments, the optical film stack is substantially clear or colorless at a viewing angle of 0 degrees, e.g. the stack has CIE coordinates a* and b*, and a* and b* are each no greater than 5. The optical stack exhibits an off-axis (e.g. 60 degree viewing angle) color in the visible light spectrum ranging from yellow to violet.

In another embodiment, a display device is described, comprising a light-emitting display surface having an image plane; and an optical film stack, as described herein arranged such that film stack is between the image and a light output surface of the display.

In yet another embodiment, a structure is described comprising a fenestration and an optical film stack as described herein.

In yet another embodiment, a multilayer p-polarization film is described comprising alternating layers of at least a first and second material, wherein the first material comprises carboxylate subunits and glycol subunits such that at least 96 mol % of the carboxylate are dimethyl naphthalene dicarboxylate and at least 91 mol % of diol subunits are derived from hexane diol, ethylene glycol, or a mixture thereof.

### BRIEF DESCRIPTION OF THE DRAWINGS

FIG. 1 is a cross-sectional view of a film stack according to one embodiment of the present description;

FIG. 2 is an illustrative multi-layer film;

FIG. 3 is an on-axis (0 degrees viewing angle) spectra comparison of two film stacks comprising a light control (e.g. privacy) film and different color shifting films; and

FIG. 4 is an off-axis (60 degrees) viewing angle spectra comparison of two film stacks comprising a light control (e.g. privacy) film and different color shifting films.

### DETAILED DESCRIPTION

Advances in display technology have resulted in brighter, higher resolution, and more energy efficient displays. The brightness and resolution of a display can be reduced, however, when an LCF is positioned in front of the display (e.g., for security purposes or as a contrast enhancement film). It is desirable to have a privacy solution that, when used in combination with a display, has a high light transmission and display resolution, yet does not compromise privacy. Further; it is also desirable to provide a non-informational colorful and vivid look to an electronic device's display area for off-axis viewers rather than the heretofore known “black out” privacy view.

The present application is directed to a film stack combining a light-collimating film (“LCF) and what is commonly referred to as a “p-polarizer” color shifting multilayer film proximate to one another.

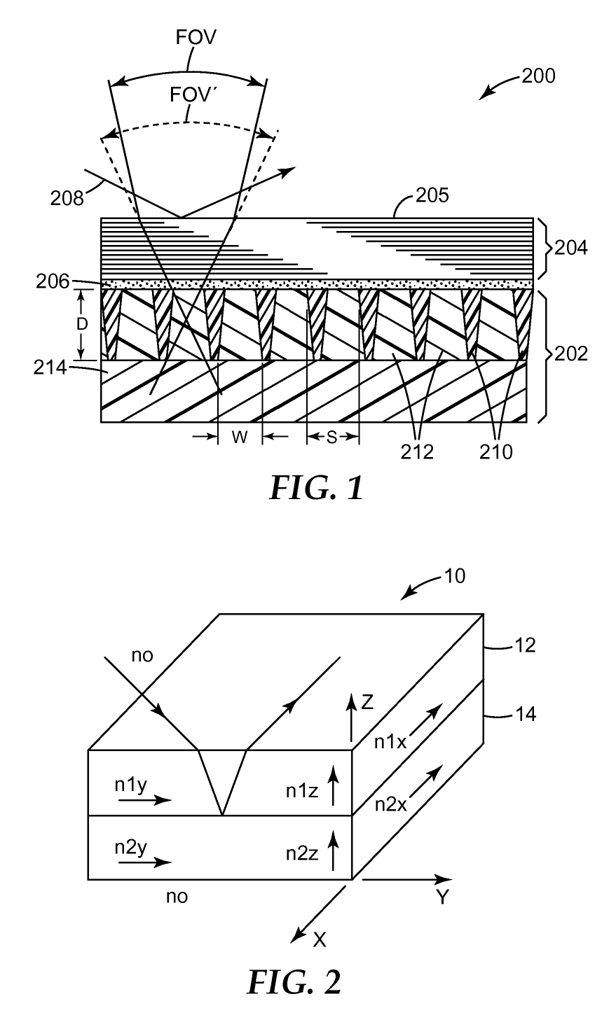

One embodiment of the film stack is illustrated in FIG. 1. The film stack 200 comprises LCF 202 and a multi-layer “p-polarizer” color shifting film 204 adhered together by an adhesive layer 206. The LCF in FIG. 2 is composed in part of transmissive regions 212 and non-transmissive regions 210 which alternate across the width of the film. The transmissive and non-transmissive regions in this embodiment are built upon a base substrate 214, which is a further component of the LCF. The multi-layer “p-polarizer” color shifting film 204 is disposed between the LCF and viewing surface 205. Light enters the film stack through the light input surface of the LCF and exits the film stack through the light output surface (i.e. viewing surface) 205 (e.g. of the color shifting film). In some embodiments, the optical stack may further comprise other films or layers between the color shifting film and light output surface.

FIG. 1 is useful in showing the reduced cut-off angle (FOV), and therefore heightened privacy, created as a result of the film stack (as opposed to an LCF alone—FOV′), in part due to the ambient light 208 reflection off of the MOF 204.

A hybrid privacy filter utilizing an LCF (e.g., element 202 in FIG. 2) and an MOF (e.g., element 204 in FIG. 2) has a better defined effective viewing angle cut-off and privacy function than either the LCF or multi-layer “p-polarizer” color shifting film alone. At the same time, the hybrid privacy filter still maintains a high level of transmission that is comparable to a stand alone light control film (for instance, axial transmission).

For simplification, it will be discussed herein the effect that certain films or film stacks have on “on-axis” transmission. Those skilled in the art will readily recognize that the desired axis of transmission may be chosen by designing the geometry of the louvers in an LCF. While in many embodiments, for instance, privacy films, on-axis transmission is perpendicular to the surface of the display image plane, it will be readily understood that for applications wherein a viewer is not typically situated perpendicular to the display image plane, a non-normal viewing axis may be desirable.

There is no substantial decrease in on-axis light transmission for a film stack including an MOF and an LCF vis á vis the LCF alone when used as a privacy filter over top of a display.

Reflection of ambient light from the MOF may begin to occur at angles close to or even equal to the cut-off angle of the LCF. The combination of the light blocking properties of the LCF in decreasing the image light transmitted through the film stack and the onset of glare reflection from the MOF from ambient light, can serve to provide a well-defined cut-off angle for privacy filters made from film stacks described herein. The combination of the LCF's ability to block transmission of the display light (typically by absorption) and the MOF's ability to create bright reflections inhibit off-axis viewers from viewing the display content.

When used as a hybrid privacy filter, the film stacks described herein may employ LCFs having much higher overall transmission, including films that would, on their own, not be effective as privacy filters. For instance, so-called contrast enhancement films, which are LCFs having higher overall transmission of image light and are not as effective at blocking off-axis viewing angles, may be used in combination with a p-polarization color shifting film to make a very effective hybrid privacy filter.

Conventional privacy filters (lacking a color shifting film) turn from clear to black outside the field of view. Hybrid privacy filters comprising a color shifting film, such as described in WO 2010/090924 turn from clear to red and then golden yellow as ambient light is reflected from the color shifting film at angles outside the field of view. The presently described hybrid filter comprising a p-polarization color shifting film that can be designed to provide various other changes in color as ambient light is reflected from the p-polarization color shifting film at angles outside the field of view.

Multilayer optical film films, such as polarizers and mirror films, are known. Such optical films comprise a plurality of distinct optical layers arranged into optical repeat units across the thickness of the film. In a simple case the optical layers, which number in the tens, hundreds, or thousands, alternate between a first and second light transmissible material in a quarter-wave stack, such that the optical repeat unit consists essentially of two optical layers of equal optical thickness. FIG. 2 shows a perspective view of one such optical repeat unit 10 in the context of a right-handed Cartesian x-y-z coordinate system, where the film extends parallel to the x-y plane, and the z-axis is perpendicular to the film, corresponding to a thickness axis. The optical repeat unit 10 includes adjacent optical layers 12, 14. The refractive indices of the individual layers 12 are denoted:
n₁ₓ, n_{1y}, n_{1z}
   for polarized light whose electric field vector oscillates along the x-, y-, and z-axes respectively. In like fashion, the refractive indices of the individual layers 14 are denoted:
n₂ₓ, n_{2y}, n_{2z}.
   In most multilayer optical film polarizers, the materials and processing conditions are tailored to produce, between adjacent optical layers, a refractive index mismatch along one in-plane axis and a substantial match of refractive indices along an orthogonal in-plane axis. If we denote the magnitude of n₂-n₁ along a particular axis as Δn, these conditions can be expressed as:
Δnₓ≈large
Δn_{y}≈0
   A film with these properties reflects normally incident light of one polarization and transmits normally incident light of an orthogonal polarization.

U.S. Pat. No. 5,882,774 (Jonza et al.) and U.S. Pat. No. 7,094,461 (Ruff et a.) describe another type of multilayer film, referred to as a “p-polarizer”. In this construction, the in-plane indices of the two materials are equal, but the z-axis indices differ. A p-polarizing films does not have any substantial reflectivity for normally incident light, whatever its polarization state or wavelength. However, for obliquely incident (i.e. off-axis) light, the p-polarizing films also reflect p-polarized light in a manner that increases monotonically with increasing angle (i.e. viewing angle). P-polarization films also do not reflect s-polarized light in any substantial amount (again ignoring any reflectivity attributed to the exposed outer surfaces of the film).

In order to achieve these optical properties, at least one of the optical layers (referred to arbitrarily as A and B, or 1 and 2) within each optical repeat unit is birefringent, such that there is a substantial match of refractive indices of adjacent layers along the in-plane axes, and a substantial mismatch of refractive indices along the thickness axis. If we denote the magnitude of n₂-n₁ along a particular axis as Δn, this set of conditions can be expressed as:
Δnₓ≈0
Δn_{y}≈0
Δn_{z}≈large
   The resulting film is referred to as an “off-axis polarizer” or a “p-polarizer”. See generally U.S. Pat. No. 5,882,774 (Jonza et al.), “Optical Film”. In the relationships shown above, zero for Δnₓ and for Δn_{y} means the difference is sufficiently small to produce a negligible amount of on-axis (θ=0) reflectivity for either polarization, e.g. less than about 20% or 15%. This will depend on the total number of optical repeat units employed in the film, with a larger number of optical layers or optical repeat units generally requiring a smaller absolute value of the in-plane index difference to maintain a low reflectivity, and also on the thickness distribution (or “layer density”—the number of layers per range of optical thickness) of the optical repeat units. For a film having a total number of optical layers of a few hundred but less than one thousand, a refractive index difference of up to about 0.02 is typically acceptable, but a difference of 0.01 or less is preferred. “Large” for Δn_{z} means large enough to produce a desired substantial amount of off-axis reflectivity, preferably at least 50% and more desirably at least 80% reflectivity for p-polarized light.

Of particular interest are p-polarizing films that produce color in the human-visible spectral region (about 400 to 700 nm) at off axis (i.e. oblique) viewing angles ranging from 40 to 80 degrees.

The reflectivity of a given optical repeat unit exhibits a maximum at a wavelength λ equal to two times the optical thickness of the optical repeat unit, at normal incidence. The optical thickness of an optical repeat unit is considered to be a constant, and equal to the sum of the optical thicknesses of the optical repeat unit's constituent optical layers for normally incident light. Within a multilayer optical film, which may contain tens, hundreds, or thousands of individual optical layers, the optical thicknesses of the optical repeat units can be chosen to all be equal such that a single, relatively narrow reflection band emerges in a desired portion of the spectrum with increasing incidence angle. Alternatively, multiple packets of optical repeat units can be used, where each packet has optical repeat units of a uniform optical thickness, but such optical thickness being different for the different packets so that distinct narrow reflection bands emerge in desired parts of the spectrum. Alternatively or additionally, thickness gradients can be employed to produce broadened reflection bands over portions of the spectrum. Multiple reflection bands can be separated by a sufficient degree to define a spectral region of high transmission (a transmission band) therebetween over a desired wavelength band.

For example, the following Table 1 exhibits various colors that can be achieved at a viewing angle of 60 degrees by use of the same resin combination described in the forthcoming examples by changing the average thickness of the (e.g. 155) layers.

TABLE 1

| Average Physical | 60° Off-Axis | Appearing | Finished Film |
|---|---|---|---|
| Layer Thickness | Center Peak | Color at 60° | Thickness (Optical |
| (nm) | Reflection | Off Axis | Layers only) (um) |
| 116 | 650 nm | Red | 18 |
| 111 | 620 nm | Orange | 17 |
| 103 | 580 nm | yellow | 16 |
| 98 | 550 nm | Yellow-Green | 15 |
| 90 | 510 nm | Green | 14 |
| 85 | 480 nm | Blue | 13 |
| 79 | 435 nm | Violet | 12 |

As is evident from the table above, specific colors can be obtained at specific off-axis angles.

In other embodiments, specific coloration can be obtained by a combination of color shifting films or a combination of “stacks” within a color shifting film wherein a first stack has a different average thickness of the layers than the second stack. For example, a stack having an average thickness that reflects blue can be combined with a stack having an average thickness that reflects yellow to produce green coloration.

In general the off-axis color ranges from violet (about 400 nm) to yellow (about 600 nm+/−about 25 nm) within the visible light spectrum. In some embodiments, the hybrid privacy filter is clear at 0 degrees and red at 60 degrees. In other embodiments, the hybrid privacy filter is clear at 0 degrees and orange at 60 degrees. In yet other embodiments, the hybrid privacy filter is clear at 0 degrees and yellow or yellow-green at 60 degrees. In yet another embodiment, the hybrid privacy filter is clear at 0 degrees and green at 40 degrees or 60 degrees. In yet another embodiment, the hybrid privacy filter is clear at 0 degrees and blue at 60 degrees or 80 degrees. In yet another embodiment, the hybrid privacy filter is clear at 0 degrees and violet at 80 degrees.

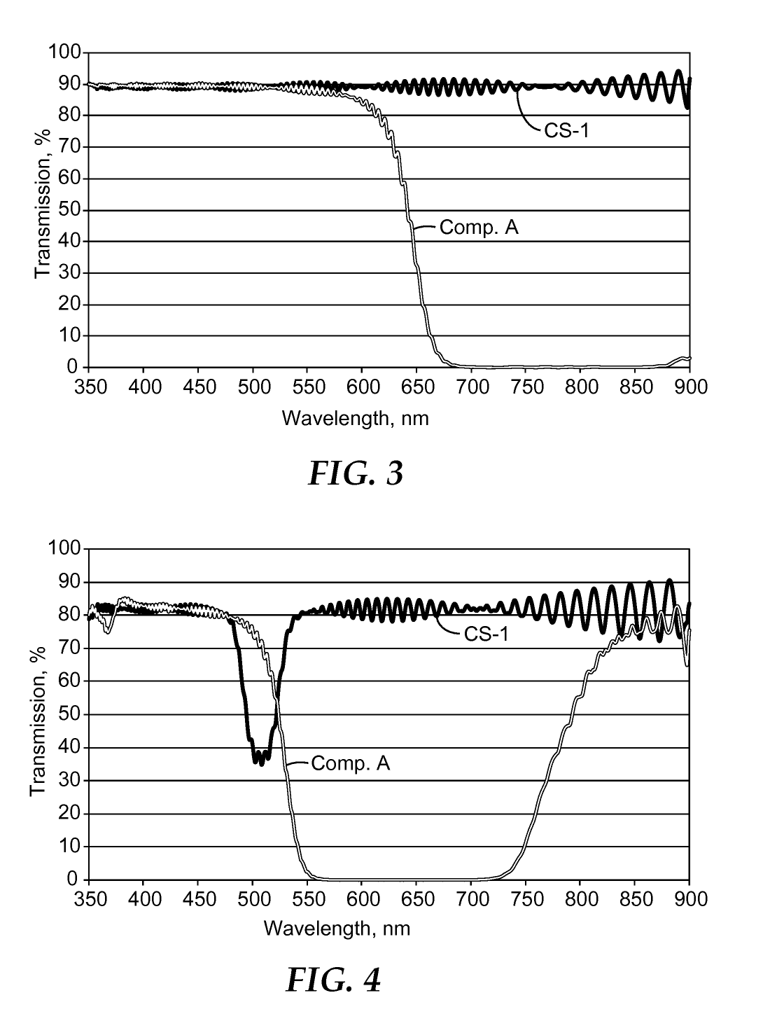

FIGS. 3 and 4 are spectra comparison of one embodied p-polarization color shifting film (i.e. CS-1) in comparison to a comparative color shifting film (i.e. Comp. A) that is not a p-polarization color shifting film. These two figures illustrate the freedom of color design that can be provided by p-polarizing films. With reference to FIG. 3, the spectra comparison at 0 degrees viewing angle, the p-polarization color shifting film (i.e. CS-1) exhibits about 90% transmission (i.e. about 10% reflectivity) throughout the visible and near visible light spectrum, 400 nm-900 nm. However, Comparative A exhibits a steep drop in transmission in the near visible wavelength, i.e. a steep increase in reflectivity beginning at a band edge around 650 nm. With reference to FIG. 4, the spectra comparison at 60 degrees viewing angle, the p-polarization color shifting film (i.e. CS-1) exhibits about 35-40% transmission (i.e. about 60-65% reflectivity) at around 500 nm. The exact color is also tunable depending on the average layer thickness. The specific reflectance of such colored peak is tunable depending on number of layers, i.e. the more layers, the more intense the color will appear to be. A reflectivity above 30% is noticeable at such viewing angle. A reflectivity of 50-70% can be characterized as “good” or “moderate” color intensity. A reflectivity of 70-100% can be achieved at layer counts of about 300-1000 with resin materials disclosed in this invention. In comparison, Comparative A, produces a strong color reflective intensity (i.e. 71-100% reflectivity).

The typical number of layer in a p-polarization color shifting film ranges from about 100 to about 300 layers. However, the intensity of color produced by the p-polarization film can be adjusted by changing the number of layers. For example, if a “fair” or “subtle” color intensity (i.e. 30%-49% reflectivity) is desired such as for an architectural effect, the number of layer can be decreased. In contrast, if a strong color intensity is desired the number of layers can be decreased. Thus in some embodiment, the minimum number of layers may be 50, or 60, or 70, or 80, or, 90. Further is other embodiments, the maximum number of layers may be 1000, or 800, or 600, or 500, or 400.

The typical layer thickness distribution can be either uniform (i.e. identical layer thickness) or with a gradient (i.e. continuously change from thick to thin).

The reflective peak can be originated by either 1^{st} order, 2^{nd} order, 3^{rd} order, 4^{th} order, 5^{th} order, 6^{th} order, or 7^{th} order reflections. The higher order reflection peaks can be used to introduce multiple colors and/or narrower peak width in visible light range at high angles.

The p-polarization film, as well as the hybrid privacy film comprising such, preferably has a substantially clear or colorless appearance on-axis (i.e. at 0 degrees viewing angle). A film can be considered substantially clear when the CIE color coordinates a* and b*, are each no greater than 5. In some embodiments, the square root of a*²+b*² is no greater than 5.

If absorbing agents (e.g. pigments and/or dyes) are added to change the on-axis appearance from clear to a particular color. The off-axis will also be affected by the inclusion of an absorbing agent. In some embodiments, the p-polarization color-shifting film is free of absorbing agents.

A variety of light transmissible materials can be used for the optical layers making up the optical repeat units of the p-polarization multi-layer films, such as described in previously cited U.S. Pat. No. 5,882,774 (Jonza et al.) and U.S. Pat. No. 7,094,461 (Ruff et a.); incorporated herein by reference. The materials are generally thermoplastic polymers and can be co-extruded from a multilayer die and subsequently cast and oriented in sequential or simultaneous stretching operations. Optically thick skin layers can be added for protection and ease of handling, which layers can become protective boundary layers between packets of optical layers within the finished film if one or more layer multipliers is used between the feedblock and the die.

In one approach that has been found advantageous, one light transmissible polymeric material (arbitrarily designated A) remains largely isotropic throughout the manufacturing process, and another (arbitrarily designated B) becomes birefringent during a stretching procedure in the manufacturing process. The stretching is carried out along both x- and y-axes so that the in-plane refractive indices of the birefringent material end up being about equal to each other, and equal to the refractive index of the isotropic material. The out-of-plane refractive index (i.e. z-index) of the birefringent material then differs substantially from the refractive index of the isotropic material. The stretched layers are typically heat seat to eliminate any residual birefringence of the isotropic material. In a particularly preferred version of this approach, material A has a relatively high (isotropic) refractive index and material B has a somewhat lower isotropic refractive index in the cast film before orientation. During orientation the refractive indices of the B material increase along the two orthogonal stretch directions to match the index of the A material, and the z-axis refractive index of the B material diminishes to widen the gap between it and the index of the A material. Meanwhile, with appropriate materials selection and careful control of the stretch conditions such as film temperature, stretch rate, and stretch ratio, the refractive index of the A material remains constant and isotropic during orientation. Material A has a high refractive index to match the in-plane refractive indices of the oriented material B, and a low enough glass transition temperature T_{g} to remain isotropic when oriented at conditions necessary to cause birefringence in material B. Preferably, the film is maintained at a temperature of at least about 20° C. above the glass transition temperature of the isotropic material during stretching.

In one embodiment, the multilayer p-polarization film comprises a first (isotropic) polymeric material that comprises dimethyl naphthalene dicarboxylate (NDC) subunits diol subunits derived from hexane diol (HD), ethylene glycol (EG), or a mixture thereof. The second polymeric material is a birefringent material such as polyester or copolyester. The weight percentage of monomers for some favored first (isotropic) polyester and copolyester materials are depicted in the following Table 2:

TABLE 2

| | Composition | | | | | |
|---|---|---|---|---|---|---|
| | 1 | 2 | 3 | 4 | 5 | 6 |
| NDC, mol % | 100% | 100% | 100% | 100% | 100% | 100% |
| HD, mol % | 100% | 80% | 70% | 60% | 50% | 40% |
| EG, mol % | 0% | 20% | 30% | 40% | 50% | 60% |

In some embodiments, at least 96 mol %, 97 mol %, 98 mol %, 99 mol %, or 100 mol % of the carboxylate subunits are dimethyl naphthalene dicarboxylate. In some embodiments, at least 91 mol %, 92 mol %, 93 mol %, 94 mol %, 95 mol %, 96 mol %, 97 mol %, 98 mol %, 99 mol % or 100 mol % of the diol subunits are derived from hexane diol, ethylene glycol, or a mixture thereof. In some embodiments, at least 10 mol %, 20 mol %, 30 mol %, 40 mol %, 50 mol %, 60 mol %, or 70 mol % of the diol subunits are derived from ethylene glycol. In some embodiments, at least 30 mol %, 40 mol %, 50 mol %, 60 mol %, 70 mol %, 80 mol %, or 90 mol % of the diol subunits are derived from hexane diol.

The following Table 3 depicts the thermal (i.e. glass transition temperature (Tg) and melt temperature (Tm)) and refractive index properties of the polyester and copolyester materials of Table 2.

TABLE 3

| | Composition | | | | | |
|---|---|---|---|---|---|---|
| | 1 | 2 | 3 | 4 | 5 | 6 |
| Intrinsic | 0.728 | 0.669 | 0.641 | 0.586 | 0.555 | 0.513 |
| Viscosity | | | | | | |
| Tg (° C.) | 58 | 62 | 67 | 72 | 78 | 85 |
| Tm-2^{nd} | 193 | 176 | 167 | None | None | None |
| (° C.) | | | | | | |
| Tm-onset | 191 | 175 | 165 | 161 | 177 | 193 |
| (° C.) | | | | | | |
| RI | 1.618 | 1.621 | 1.623 | 1.623 | 1.626 | 1.631 |

The following Table 4 depicts the measured refractive indicies of a layer comprising the polyester or copolyester material of Table 2.

TABLE 4

| Layer A | Layer A | | | Layer B (PET) | | |
|---|---|---|---|---|---|---|
| Composition | nx | ny | nz | nx | ny | nz |
| 1 | 1.618 | 1.618 | 1.618 | 1.640 | 1.640 | 1.488 |
| 2 | 1.621 | 1.621 | 1.621 | 1.645 | 1.625 | 1.498 |
| 3 | 1.623 | 1.623 | 1.623 | 1.641 | 1.636 | 1.491 |
| 4 | 1.623 | 1.623 | 1.623 | 1.650 | 1.633 | 1.485 |
| 5 | 1.626 | 1.626 | 1.626 | 1.643 | 1.641 | 1.484 |
| 6 | 1.631 | 1.631 | 1.631 | 1.646 | 1.631 | 1.491 |

Additional layers and coatings can also be added to modify optical, mechanical, or chemical properties of the film.

The LCFs used in the present description may be created by multiple processes. One useful process is skiving, further explained in U.S. patent application Re. 27,617 to Olsen. Another useful process is microreplication. One specific example of microreplication involves the following steps: (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed base (or substrate layer) and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions, and has a surface energy that allows clean removal of the polymerized material from the master. One or more of the surfaces of the base film (or substrate layer) can optionally be primed or otherwise be treated to promote adhesion of the optical layer to the base.

It is appreciated that transmission is a factor of the polymerizable resin of the light-collimating film as well as the included wall angle. In some embodiments, the transmission at an incident angle of 0° is at least 50%. The transmission at an incident angle of 0° can be at least 50%, 55%, 60%, 65%, 70%, 75%, or 80%. The transmission can be measured with various known techniques. As used herein, the on-axis transmission was measured with an instrument commercially available from BYK Gardner under the trade designation “Haze-Guard Plus (catalog #4725).”

As depicted in FIG. 1, the transparent microstructures between grooves have an included wall angle θ as depicted in FIG. 2, a maximum transparent microstructure width, W; an effective height D; and center-to-center spacing. Wall angle θ is equal to 2 times the angle formed between the transparent film interface with the light absorbing element nearly along the “D” dimension direction and a plane normal to the microstructured surface. The viewing range Φ_{T} is about twice the maximum viewing half angle. The viewing range Φ_{T} can also be asymmetric for example when the half angle Φ₁ is not equal to the half angle Φ₂.

Light-collimating films can be made that have relatively large included wall angles. Larger wall angles can increase the maximum width of the light absorbing regions, thereby decreasing the percent transmission at normal incidence.

In preferred embodiments, the included wall angle of the microstructures averages less than 6° and more preferably averages less than 5° (e.g. less than 4°, 3°, 2°, 1°, or 0°).

Smaller (i.e. steeper) wall angles are amenable to producing grooves having a relatively high aspect ratio (H/W) at a smaller center-to-center spacing S, thereby providing a sharper image viewability cutoff at lower viewing angles. In some embodiments, the transparent microstructures have an average height, H, and an average width at its widest portion, W, and H/W is at least 2.0, preferably 2.5, and more preferably 3.0 or greater.

Depending on the intended end use light collimating films having a variety of viewing cutoff angles can be prepared. In general, the viewing cutoff angle ranges from 40° to 90° or even higher. The following Table 1 provides exemplary viewing cutoff angles as a function of aspect ratio.

TABLE 1

| Aspect Ratio | View Angle (deg) |
|---|---|
| 1.50 | 120 |
| 1.75 | 100 |
| 2.0 | 90 |
| 3.0 | 60 |
| 4.0 | 48 |
| 5.0 | 40 |

For computer privacy films as well as hand-held devices, cutoff viewing angles are preferably 60° or less.

In some embodiments, the pitch is no greater than 0.040 mm, 0.039 mm. 0.038 mm, 0.037 mm, 0.036 mm or less. A smaller included wall angle and less pitch allows for higher performance with less height. In some embodiments, the height is no greater than 0.10 mm, or 0.090 mm, or 0.080 mm, or 0.070 mm. Light-collimating films having such reduced height are further described in WO2010/148082; incorporated herein by reference. Less height results in less overall thickness of the film. Thinner films tend to have better touch sensitivity.

In embodiments wherein the non-transmissive region is absorptive, it may be desirable to minimize reflections of incident light from a display that is transmitted through the film stack. Such reflections may be minimized by what is known as index-matching the non-transmissive and transmissive regions of the LCF. In some embodiments, the index of refraction of the absorptive region, n2, is selected such that, in relation to the index of refraction of the transmissive region, n1, the relationship satisfies: |n2−n1|≧0.005. However, in certain instances, internal reflections may be desirable. Therefore, in some embodiments, it may be desirable for the relationship between n2, the index of refraction of the absorptive region, and n1, the index of refraction of the transmissive region, to be such that n2−n1 is less than −0.005.

The LCFs described herein include a plurality of non-transmissive regions. In some embodiments, the non-transmissive regions can be a plurality of channels, as shown elsewhere in the description. In some cases, the LCF can include a plurality of columns such as shown in FIG. 2b of U.S. Pat. No. 6,398,370 (Chiu et al.). In some cases, the LCF described herein can be combined with a second LCF, as also described in U.S. Pat. No. 6,398,370. In other embodiments, the non-transmissive regions are columns, posts, pyramids, cones and other structures that can add angular-dependent light transmitting or light blocking capabilities to a film.

In some embodiments, LCFs are designed with non-transmissive regions that are absorptive regions. In such embodiment, the non-transmissive regions comprise a light-absorbing material that absorbs or blocks light at least a portion of the visible spectrum. The light absorbing material can be coated or otherwise provided in grooves or indentations in a light transmissive film to form light absorbing regions. Light absorbing materials can include a black colorant, such as carbon black. The carbon black may be a particulate carbon black having a particle size less than 10 microns, for example 1 micron or less. The carbon black may, in some embodiments, have a mean particle size of less than 1 micron. In yet further embodiments, the absorbing material, (e.g., carbon black, another pigment or dye, or combinations thereof) can be dispersed in a suitable binder. Light absorbing materials also include particles or other scattering elements that can function to block light from being transmitted through the light absorbing regions.

In other embodiments, it may be desirable to create non-transmissive regions that are non-black in color. For example white louvers in an LCF may be created by use of white pigments such as titanium dioxide.

The transparent microstructures of a LCF are typically comprised of the reaction product of a polymerizable resin. The polymerizable resin can comprise a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds.

The LCF may also be partially composed of a base substrate layer (element 214 in FIG. 1). Particularly useful base materials include polyethylene terephthalate (PET), polycarbonate (PC), acrylic (PMMA), glass, or other light-transmissive (e.g. film) material.

The hybrid privacy filter comprises a p-polarization color shifting film and a light control film proximate to one another. As used herein, “proximate” to one another means that the films are either in contact with one another or, if they are separated, the material interspersed between them does not impart or detract from the optical functionality to the film stack.

In some embodiments, the LCF and p-polarization color shifting film may be adhered together through use of an adhesive (e.g., element 206 in FIG. 2). An adhesive layer may therefore be located between the color shifting film and the light control film. The adhesive may be partially opaque or optically clear, but will preferably be optically clear (or transparent) so as to not impede light transmission through the film stack. The adhesive may be cured by any number of suitable methods, such as radiation. One particularly suitable method is curing by ultraviolet radiation.

Appropriate adhesives for use in the present invention may also be pressure-sensitive adhesives. Particularly useful adhesives may include transfer adhesives, or those that are applied by laminating. A useful laminating process is described in commonly owned PCT Publication WO2009/085581.

The film stacks described herein are particularly useful as a component of a display device as a so-called hybrid privacy filter. The hybrid privacy filter may be used in conjunction with a display surface, wherein light enters the hybrid privacy filter on the input side of the light control film and exits the opposing side of the hybrid privacy filter. In some embodiments, the light exits the color shifting film. In other embodiments, the light may exit though a (e.g. protective) film or film layer disposed above the p-polarization color shifting film.

Various (e.g. backlit) light-emitting electronic devices with displays may be used in conjunction with the present invention including laptop monitors, external computer monitors, tablet computer monitors, cell phone displays, televisions, smart phones, consoles, or any other similar plasma, LCD, LED, etc. type of display. Such display devices generally comprises a light-emitting display having an image plane and the optical film stack described herein arranged such that film stack is between the image plane and a light output surface of the display.

The optical stacks described herein are contemplated useful for other articles such as sunglasses, document coversheets, etc.

In further embodiments, the film stacks described herein may be useful as coverings for glass. For instance, the film stacks may be laminated onto or within fenestrations. The fenestrations may be selected from a glass panel, a window, a door, a wall, and a skylight unit. These fenestrations may be located on the outside of a building or on the interior. They may also be car windows, airplane passenger windows, or the like. Advantages of incorporating these film stacks into fenestrations include reduced IR transmission (which may lead to increased energy savings), ambient light blocking, privacy, and decorative effects.

The present description should not be considered limited to the particular examples described herein, but rather should be understood to cover all aspects of the description as fairly set out in the attached claims. Various modifications, equivalent processes, as well as numerous structures to which the present description can be applicable will be readily apparent to those of skill in the art to which the present description is directed upon review of the instant specification. The foregoing description can be better understood by consideration of the embodiments shown by the testing results and examples that follow.

### EXAMPLES

All parts, percentages, ratios, etc. in the examples are by weight, unless noted otherwise. Solvents and other reagents used were obtained from Sigma-Aldrich Chemical Company; Milwaukee, Wis. unless specified differently.

### Preparation of Copolyester for Isotropic Layer

A copolyester was synthesized in a batch reactor with the following raw material charge: 3664 g dimethyl naphthalene dicarboxylate, 886 g hexane diol, 1583 g ethylene glycol, 0.4 g zinc acetate, 1.25 g cobalt acetate, and 3 g tetrabutyl titanate. Under pressure of 0.20 MPa, this mixture was heated to 254° C. while removing methanol. Then 1.61 g of triethyl phosphonoacetate was charged to the reactor and the pressure was gradually reduced to 133 Pa while heating to 285° C.

The condensation reaction by-product, ethylene glycol, was continuously removed until a polymer with an intrinsic viscosity of 0.555 dL/g, as measured in 60/40 wt. % phenol/o-dichlorobenzene at 86° C., was produced. This material, a thermoplastic polymer, had a glass transition temperature T_{g} of 79° C. as measured by DSC using ASTM D3418 with a scan rate of 20° C./min, and at a relative humidity of about 50%. The thermal history of the polymer was removed as a factor by performing two DSC heat scans on the sample and recording the T_{g} of the second heat scan.

An Advanced Light Control Film (ALCF), which is a louver film created by microreplication, was obtained from 3M Company, St. Paul, Minn., under the trade designation “3M™ Filters for Notebook Computers and LCD Monitors”. This film was used as a privacy filter installed on a LCD display panel in an ambient light of about 200-500 lux. The privacy function results are summarized in the table below along with results for Comparative Example C-2.

A p-polarization color shifting film (CS-1) was made as generally described in U.S. Pat. No. 7,094,461. The multilayer mirror film was made with PHEN (50/50) Resin and PET using a 155 layer feed block. The film was cast and then stretched. Multiple runs were made producing cast film multilayer core thicknesses was in the range of 0.25-1 mm (10-40 mils). The cast films were then stretched at about 90-110° C. biaxially to various draw ratios in the range from 3×3 to 5×5. The stretched films were then heat set at 230° C. for 10-50 seconds to melt out any residual birefringence in the PHEN layers.

One of the 155 layer films made by above described process was selected that appeared green when viewed off-axis at about 60 degrees. The film had average layer thickness of about 90 nm. When this film was used as a privacy filter installed on a LCD display panel in an ambient light of about 200-500 lux, the film was largely transparent when viewed from the on-axis direction and appeared to be in green in off-axis reflection at about 40-60 degrees.

### Example 1

CS-1 was hand laminated to the ALCF louver film using 3M™ Optically Clear Adhesive 8171 (available from 3M Company, St. Paul, Minn.). The resulting laminate was tested visually as a privacy filter on a LCD screen in an ambient light of about 200-500 lux.

The privacy filter based on this composite structure was clear (i.e. colorless) when viewed from the on-axis direction when installed on a LCD display panel, free of color distortion. This composite privacy filter appeared in a vibrant green color when viewed in reflection from off-axis at about 40 degrees that shifted to a blue color when viewed at an angle of about 60 degrees. The privacy function results are summarized in table below. As shown in the table, the filter based on the composite structure was very effective in blocking the view from 35 degrees or above when compared to a louver based privacy filter. With particular regard to the viewing angle cut-off and privacy function, the hybrid privacy filter of Example 1 reached complete privacy (0% visibility of display information) at a 40 degree angle whereas the ALCF alone did not achieve the same level of complete privacy until about 65 degrees. This example demonstrated that a hybrid privacy filter comprising an ALCF louver film and a p-polarizing color shifting film has an enhanced privacy function over an ALCF privacy filter alone.

| Angle from | ALCF | CS-1 | Ex. 1 |
|---|---|---|---|
| Normal, degree | (independently) | (independently) | ALCF + CS-1 |
| 0 | ◯ | ◯ | ◯ |
| 5 | ◯ | ◯ | ◯ |
| 10 | ◯ | ◯ | ◯ |
| 15 | ◯ | ◯ | ◯ |
| 20 | ◯ | ◯ | ◯ |
| 25 | Δ | ◯ | Δ |
| 30 | Δ | ◯ | Δ |
| 35 | ▪ | ◯ | ▪ |
| 40 | ▪ | ◯ | X |
| 45 | ▪ | ◯ | X |
| 50 | ▪ | Δ | X |
| 55 | ▪ | Δ | X |
| 60 | ▪ | Δ | X |
| 65 | X | Δ | X |
| 70 | X | Δ | X |
| 75 | X | Δ | X |
| 80 | X | Δ | X |
| 85 | X | Δ | X |
| 90 | X | Δ | X |

Visual Privacy Level Inspection
◯: Good visibility, no privacy (>50% peak image contrast of normal angle)
Δ: Some impeded visibility, some privacy (<20% peak image contrast of normal angle)
▪: Severely impeded visibility, effective privacy (<5% peak image contrast of normal angle)
X: Total invisibility, complete privacy

### Example 2

Another p-polarization color-shifting film (CS-2) was made by the above described process. This film had 155 layers and an average layer thickness of about 85 nm that appeared blue when viewed off-axis at about 60 degrees.

CS-2 was hand laminated to the ALCF louver film using 3M™ Optically Clear Adhesive 8171 (available from 3M Company, St. Paul, Minn.). The resulting laminate was tested visually as a privacy filter on a LCD screen in an ambient light of about 200-500 lux.

The privacy filter based on this composite structure was clear (i.e. colorless) when viewed from the on-axis direction when installed on a LCD display panel, free of color distortion. This composite privacy filter gave a vibrant blue to violet color in reflection when viewed from off-axis at about 40-60 degrees. The privacy function results are summarized in table below. As shown in the table, the filter based on the composite structure is more effective in blocking the view from 55 to 60 degrees.

| Angle from | ALCF | Ex. 2 |
|---|---|---|
| Normal, degree | (independently) | ALCF + CS-2 |
| 0 | ◯ | ◯ |
| 5 | ◯ | ◯ |
| 10 | ◯ | ◯ |
| 15 | ◯ | ◯ |
| 20 | ◯ | ◯ |
| 25 | Δ | Δ |
| 30 | Δ | Δ |
| 35 | ▪ | ▪ |
| 40 | ▪ | ▪ |
| 45 | ▪ | ▪ |
| 50 | ▪ | ▪ |
| 55 | ▪ | X |
| 60 | ▪ | X |
| 65 | X | X |
| 70 | X | X |
| 75 | X | X |
| 80 | X | X |
| 85 | X | X |
| 90 | X | X |

Visual Privacy Level Inspection
◯: Good visibility, no privacy (>50% peak image contrast of normal angle)
Δ: Some impeded visibility, some privacy (<20% peak image contrast of normal angle)
▪: Severely impeded visibility, effective privacy (<5% peak image contrast of normal angle)
X: Total invisibility, complete privacy

### Comparative A

Comparative A is a hybrid privacy film commercially available from 3M under the trade designation “3M Gold Privacy Filter” comprising a privacy filter adhesively laminated to a color shifting film. Following is a color comparison as a function of viewing angle of Comparative A and Examples 1 and 2 as described above.

| Viewing | | Color | | Color | | Color |
|---|---|---|---|---|---|---|
| Angle, ° | Comparative A | Intensity | CS-1 + ALCF | Intensity | CS-2 + ALCF | Intensity |
| 0 | Clear | None | Clear | None | Clear | None |
| 20 | Clear | None | Clear | None | Clear | None |
| 40 | red | ◯ | Yellow | Δ | Green | ▪ |
| 60 | orange | ◯ | Green | Δ | Blue | ▪ |
| 80 | yellow | ◯ | Blue | Δ | Violet | ▪ |

Strong - ◯ (71-100% Reflectivity)
Good - Δ (50 to 70% Reflectivity)
Fair - ▪ (30% to 49% Reflectivity)

Although the reflectivity can vary with the number of layers, the reflectivity expressed above is representative of a multilayer film having 100 to 300 layers. As the numbers of layer increases, the reflectivity increases. Spectra comparisons of Comparative Example A and CS-1+ALCF are depicted in FIGS. 3-4.

1. An optical film stack comprising
a light control film; and
a p-polarization color shifting film.

2. The optical film stack of claim 1, wherein the p-polarization film has no reflection band of reflectivity greater than 15% for a viewing angle of 0 degrees.

3. The optical stack of claim 1 wherein the p-polarization color shifting film comprises alternating layers of at least a first and second material, the alternating layers defining a coordinate system with mutually orthogonal x- and y-axes extending parallel to the layers and with a z-axis orthogonal to the x- and y-axes, the alternating layers having a refractive index difference along the x- and y-axes of no more than 0.015, the alternating layers also having a refractive index difference along the z-axis of at least 0.1.

4. The optical film stack of claim 3, wherein the alternating layers have a refractive index difference along the x- and y-axis of no more than 0.01.

5. The optical film stack of claim 3, wherein the first material is substantially isotropic in refractive index and the second material is birefringent.

6. The optical film stack of claim 3, wherein the second material has a refractive index along the z-axis that is less than a refractive index of the second material along the x- and y-axes.

7. The optical film stack of claim 3, wherein the first material has an isotropic refractive index of at least 1.61.

8. The optical film stack of claim 1, wherein the p-polarizing color shifting film has at least 100 layers.

9. The optical film stack of claim 8 wherein the average thickness of the layers ranges from about 80 to 120 nm.

10. The optical film stack of claim 1 wherein at a viewing angle of 0 degrees, the stack has CIE coordinates a* and b*, and a* and b* are each no greater than 5.

11. The optical stack of claim 1 wherein the optical film stack exhibits an off-axis color in the visible light spectrum.

12. The optical film stack of claim 11 wherein at a viewing angle of 60 degrees the optical film stack exhibits a color ranging from yellow to violet.

13. The optical film stack of claim 1 wherein the light control film comprises a plurality of light-absorbing non-transmissive regions.

14. The optical film stack wherein the p-polarization color shifting film increases the invisibility at off-axis viewing angels relative to the light control film alone.

15. A display device, comprising:
a light-emitting display having an image plane; and
an optical film stack according to claim 1 arranged such that film stack is between the image plane and a light output surface of the display.

16. The optical display of claim 15 wherein the display is selected from a television, a computer monitor, a laptop display, a tablet display, a cell phone, and a console.

17. A structure comprising a fenestration and the optical film stack of claim 1.

18. The structure of claim 17 wherein the fenestration is selected from a glass panel, a window, a door, a wall, and a skylight unit.

19. A multilayer film wherein the film is a p-polarization film comprising alternating layers of at least a first and second material, the first material comprising carboxylate subunits and glycol subunits wherein at least 96 mol % of the carboxylate are dimethyl naphthalene dicarboxylate and at least 91 mol % of diol subunits are derived from hexane diol, ethylene glycol, or a mixture thereof; wherein the first material is isotropic and the second material is birefringent after the film is formed.

20. The multilayer film of claim 19 wherein the second material is a polyester or copolyester material.

21-22. (canceled)
